(19) United States
(12) Patent Application Publication
(10) Pub. No.: US 2006/0070578 A1
(43) Pub. Date: Apr. 6, 2006

(54) FEEDER APPARATUS, AND METHODS OF CONSTRUCTING AND UTILIZING SAME

(76) Inventor: Samuel T. Pavlik, PRESCOTT, MI (US)

Correspondence Address: IRVING M. WEINER;WEINER & BURT, P.C., 635 N. US-23, P.O.BOX 186, HARRISVILLE, MI, 48740, US

(21) Appl. No.: 10/908,028

(22) Filed: Apr. 26, 2005

Related U.S. Application Data
(60) Provisional application No. 60/616,313, filed on Oct. 6, 2004.

(51) Int. Cl. A01K 5/00

(52) U.S. Cl. 119/51.11

(57) ABSTRACT

A livestock hay saver which protects hay from the elements and contamination. The apparatus has timer-operated doors which provide control to completely automated means for providing feed to horses and cattle. Its battery-operated, solar-recharged power system makes it completely portable and minimizes the need for user attention or maintenance.

### DESCRIPTION

The present patent application is based on and claims priority from U.S. Provisional Patent Application Ser. No. 60/616,313 filed Oct. 6, 2004, the entire contents of which are incorporated herein by reference thereto.

The present invention relates generally to a novel and unique feeder apparatus, and methods of constructing and utilizing same.

More particularly, the present invention relates to an automatic livestock feeder apparatus, and methods of constructing and utilizing same.

### BACKGROUND OF THE INVENTION

At the present time there are a variety of hay rings and open field feeding stations on the market for horses and cattle. In many cases, these conventional devices permit the hay to rest directly on the ground, thereby enabling a substantial portion of it to become contaminated by mud and animal waste, and subject to the elements. They are also often uncovered, thereby allowing the hay or other feed to become saturated and eventually ruined by rain or other precipitation. Such conventional feeders also provide little control of feeding rates, thereby permitting animals to be overfed.

There have been some attempts to address the problems mentioned hereinabove.

The prior, but not necessarily relevant, art is exemplified by the following United States Patents:
Bullock U.S. Pat. No. 1,442,382 entitled “AUTOMATIC FEED BOX”;
Carr et al. U.S. Pat. No. 3,845,744 entitled “ANIMAL SELF FEEDER”;
Ruth U.S. Pat. No. 3,884,189 entitled “MULTIPLE COMPARTMENT ANIMAL FEEDER”;
Pitzen U.S. Design Pat. No. 286,455 entitled “AUTOMATIC FEEDER FOR BARN ANIMALS”;
Peters et al. U.S. Design Pat. No. 332,156 entitled “AUTOMATIC FEEDER FOR ANIMALS, INCLUDING LIVESTOCK, HOUSEHOLD PETS, AND AQUATIC LIFE”;
Eberhardt U.S. Pat. No. 5,447,120 entitled “DISPENSER FOR BALES OF HAY”;
Jenson U.S. Pat. No. 5,899,169 entitled “AUTOMATIC HAY, GRAIN AND PELLET FEEDER FOR LIVESTOCK”; and
Sturgis U.S. Pat. No. 6,550,421 entitled “AUTOMATIC HAY FEEDER”.

The prior art devices do not completely solve the problems mentioned hereinabove, and/or require an inordinate amount of personal attention and maintenance, and/or are expensive to fabricate and maintain.

It is a primary desideratum of the present invention to avoid the animadversions of the prior art and conventional devices and techniques, and at the same time to provide a novel, efficient and relatively inexpensive solution to the problems described hereinabove.

### SUMMARY OF THE INVENTION

The present invention provides a feeder apparatus comprising: a transportable housing structure within which food for animals may be periodically stored; said transportable housing structure being provided with one or more selectively openable and closable doors which permit animals to gain access to at least some portion of said food when one or more of said doors are at least partially opened; first means for opening and closing said doors; second means operably connected to said first means for operating said first means at preselected times; third means operably connected to said first and second means for supplying power to said first and second means; and said third means including one or more photovoltaic devices.

It is a primary object of the present invention to provide a feeder apparatus as described hereinabove, wherein said apparatus comprises a livestock hay saver, and said transportable housing structure consists of a shed-style structure.

Another object of the present invention is to provide a feeder apparatus as described hereinabove, wherein said transportable housing structure has its lower base mounted on a pair of beveled front end skids which permit the feeder apparatus to be towed into position via a tractor.

Yet a further object of the present invention is to provide a feeder apparatus as described hereinabove, wherein the roof of said transportable housing structure is provided with a slight slope thereto, and which roof may be fabricated from plastic or clad with standard roof decking.

Another object of the present invention is to provide a feeder apparatus as described hereinabove, wherein the rear side of the apparatus may be provided with a pair of full-sized vertically hinged doors which would provide access to the apparatus for loading it with hay.

The aforementioned objects, advantage and other features will become more apparent to those persons skilled in this particular area of technology and to other persons after having been exposed to the detailed description set forth hereinbelow when read in conjunction with the accompanying drawings.

### BRIEF DESCRIPTION OF THE DRAWINGS

FIG. 1 is a perspective view of a preferred embodiment in accordance with the present invention.

FIG. 2 is a schematic representation of the electrical or mechanical components of the invention.

FIG. 3 is an end elevational view of the slidable doors of the present invention.

FIG. 4 is a front elevational view of the selectively operable and movable doors, such as the door shown in FIG. 3.

### DETAILED DESCRIPTION OF THE PREFERRED EMBODIMENT

The feeder apparatus in accordance with a preferred embodiment of the present invention is referred to generally by the reference numeral 10. The feeder apparatus 10 includes a transportable housing structure 11 within which food 12 for animals may be periodically stored.

Preferably, but not necessarily, the transportable housing structure 11 may take the form of a shed-like structure which would measure 7′ 8″ high by 8′ long by 6′ wide. The transportable housing structure 11 would include a lower base 13 mounted on a pair of beveled front end skids 14 and 15 which would permit the entire feeder apparatus 10 to be towed into position by the use of a tractor.

Preferably, but not necessarily, the transportable housing structure 11 would be provided with a roof 16 which has a slight slope to facilitate the flow thereoff of precipitation.

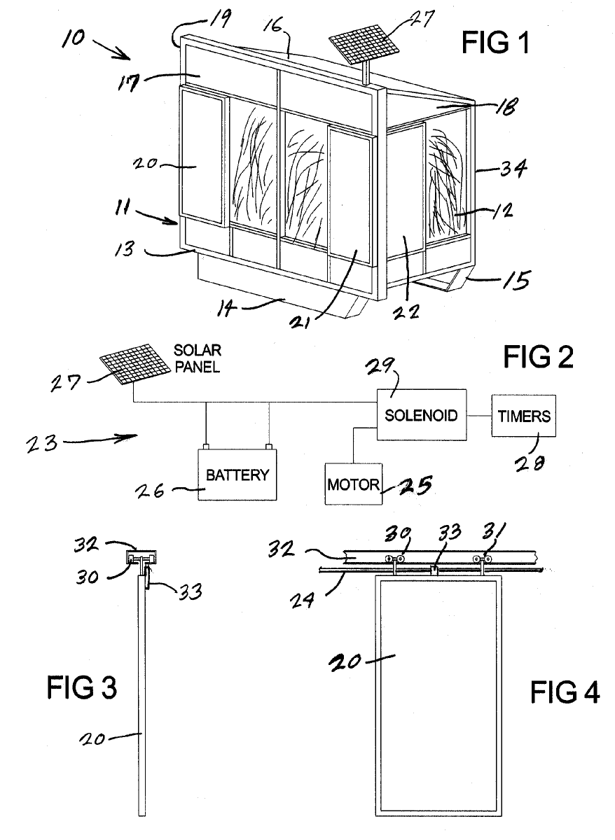

With reference to FIG. 1, there is shown the front side 17 and one end side 18 of the feeder apparatus 10. The end side 19 hidden from view in FIG. 1 is similar to the end side 18 clearly shown in FIG. 1. Both end sides 18 and 19 and the front side 17 are provided with selectively openable and closable doors 20, 21 and 22 to permit animals to gain access to at least some of the food 12 stored in the feeder apparatus 10 when one or more of the doors 20, 21 and 22 are at least partially opened.

Preferably, but not necessarily, the rear side 34 of the feeder apparatus 10 (hidden from view in FIG. 1) would include a pair of full-size vertically hinged doors which would provide access to the housing structure 11 for loading it with hay 12 or other food periodically.

The front and end doors 20, 21 and 22 would be controlled by a motorized opener/closer system 23. The motorized system 23 would include a system of sprockets and roller chains, as well as cables 24 and pulleys linked to an electric motor 25.

The electric motor 25 and other electrical components of the apparatus would be powered by a deep cycle lead-acid battery 26, the charge of which would be maintained by a recharging circuit within a photovoltaic panel, indicated in the drawings as a solar panel 27. The operation of the motorized door system 23 would be automatically regulated by digital timers 28. Preferably, but not necessarily, the system 23 can be set to open for one to eight open cycles each day.

As shown in FIG. 2, the solar panel 27 is electrically connected to the battery 26, and the solenoid 29, which in turn is connected to the timers 28 and motor 25.

The unit marked solenoid 29 in FIG. 2 also includes appropriate relays.

The feeder apparatus 10 in accordance with the present invention thoroughly protects hay 12 or other animal food from mud/manure contamination, as well as shielding it from the rain, snow and other elements. In use, the feeder apparatus 10 would be towed into position by way of a tractor on its integral skid-style base 13, 14 and 15.

Periodically, up to eight times a day, the timer-controlled door opener mechanism 23 would simultaneously open the doors 20, 21 and 22 on the front and end sides 17, 18 and 19, respectively, to allow animals to feed. The doors 20, 21 and 22 would then be automatically closed at the end of each feeding period.

In addition to providing full protection from the elements, the feeder apparatus 10 in accordance with the present invention enables it to effectively prevent overfeeding, thereby ensuring good animal health while simultaneously minimizing the waste of feed 12.

The feeder apparatus 10 employs a battery/voltaic cell base power system 23, which is a configuration that enables it to be set up virtually anywhere. This also simplifies maintenance and eliminates the risk of electrocution-related accidents.

The feeder apparatus 10 in accordance with the present invention would help reduce the operating costs of a horse ranch, dairy farm, cattle ranch, or related establishment. It also minimizes the amount of labor that would be required to provide animals with feed 12, particularly during the winter months.

With reference to FIGS. 3 and 4, there is shown a typical door 20 suspended by rollers 30 and 31 in a track 32. Each door 20, 21 or 22 is provided with a bracket 33 near its upper mid point connected to a cable 24 of the motorized door opening/closer system 23.

There has been illustrated in the accompanying drawings, and described hereinabove, only one unique and novel preferred embodiment of the present invention which can be constructed in various different sizes and shapes.

It should be understood that many changes, modifications, variations, and other uses and applications of the present invention will become apparent to persons skilled in this particular area of technology after having been exposed to the present patent specification and accompanying drawings.

Any and all such changes, modifications, variations, and other uses and applications which do not depart from the spirit and scope of the present invention are therefore covered by and embraced within the present application and the patent claims set forth hereinbelow.

What is claimed is:

1. A feeder apparatus comprising:
a transportable housing structure within which food for animals may be periodically stored;
said transportable housing structure being provided with one or more selectively openable and closable doors which permit animals to gain access to at least some portion of said food when one or more of said doors are at least partially opened;
first means for opening and closing said doors;
second means operably connected to said first means for operating said first means at preselected times;
third means operably connected to said first and second means for supplying power to said first and second means; and
said third means including one or more photovoltaic devices.

2. A feeder apparatus according to claim 1, wherein:
said transportable housing structure has a lower base mounted on a pair of beveled front end skids which permit said feeder apparatus to be towed into position via a tractor.

3. A feeder apparatus according to claim 1, wherein:
said transportable housing structure is provided with a roof which has a slight slope to facilitate the flow thereoff of precipitation.

4. A feeder apparatus according to claim 2, wherein:
said transportable housing structure is provided with a roof which has a slight slope to facilitate the flow thereoff of precipitation.

5. A feeder apparatus according to claim 1, wherein:
said first means for opening and closing said doors comprises a motorized opener/closer system.

6. A feeder apparatus according to claim 2, wherein:
said first means for opening and closing said doors comprises a motorized opener/closer system.

7. A feeder apparatus according to claim 3, wherein:
said first means for opening and closing said doors comprises a motorized opener/closer system.

8. A feeder apparatus according to claim 4, wherein:
said first means for opening and closing said doors comprises a motorized opener/closer system.

9. A feeder apparatus according to claim 5, wherein:
said motorized opener/closer system includes a system of sprockets and roller chains, and cables and pulleys linked to an electric motor.

10. A feeder apparatus according to claim 6, wherein:
said motorized opener/closer system includes a system of sprockets and roller chains, and cables and pulleys linked to an electric motor.

11. A feeder apparatus according to claim 7, wherein:
said motorized opener/closer system includes a system of sprockets and roller chains, and cables and pulleys linked to an electric motor.

12. A feeder apparatus according to claim 8, wherein:
said motorized opener/closer system includes a system of sprockets and roller chains, and cables and pulleys linked to an electric motor.

13. A feeder apparatus according to claim 1, wherein:
at least one of said one or more photovoltaic devices includes a solar panel; and
said first means and said second means are powered by a deep cycle lead-acid battery, the charge of which is maintained by a recharging circuit within said solar panel.

14. A feeder apparatus according to claim 2, wherein:
at least one of said one or more photovoltaic devices includes a solar panel; and
said first means and said second means are powered by a deep cycle lead-acid battery, the charge of which is maintained by a recharging circuit within said solar panel.

15. A feeder apparatus according to claim 3, wherein:
at least one of said one or more photovoltaic devices includes a solar panel; and
said first means and said second means are powered by a deep cycle lead-acid battery, the charge of which is maintained by a recharging circuit within said solar panel.

16. A feeder apparatus according to claim 4, wherein:
at least one of said one or more photovoltaic devices includes a solar panel; and
said first means and said second means are powered by a deep cycle lead-acid battery, the charge of which is maintained by a recharging circuit within said solar panel.

17. A feeder apparatus according to claim 5, wherein:
at least one of said one or more photovoltaic devices includes a solar panel; and
said first means and said second means are powered by a deep cycle lead-acid battery, the charge of which is maintained by a recharging circuit within said solar panel.

18. A feeder apparatus according to claim 6, wherein:
at least one of said one or more photovoltaic devices includes a solar panel; and
said first means and said second means are powered by a deep cycle lead-acid battery, the charge of which is maintained by a recharging circuit within said solar panel.

19. A feeder apparatus according to claim 9, wherein:
at least one of said one or more photovoltaic devices includes a solar panel; and
said first means and said second means are powered by a deep cycle lead-acid battery, the charge of which is maintained by a recharging circuit within said solar panel.

20. A feeder apparatus according to claim 12, wherein:
at least one of said one or more photovoltaic devices includes a solar panel; and
said first means and said second means are powered by a deep cycle lead-acid battery, the charge of which is maintained by a recharging circuit within said solar panel.
